(19) United States
(12) Patent Application Publication
(10) Pub. No.: US 2002/0167678 A1
(43) Pub. Date: Nov. 14, 2002

(54) Image processing method, image processing equipment and image forming equipment

(75) Inventor: Yoshinori Shiraishi, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: FUJITSU LIMITED, Kawasaki (JP)

(21) Appl. No.: 09/957,078

(22) Filed: Sep. 21, 2001

(30) Foreign Application Priority Data
May 11, 2001 (JP) 2001-140830

(51) Int. Cl. G06F 15/00; B41B 1/00

(52) U.S. Cl. 358/1.2; 358/1.13

(57) ABSTRACT

Disclosed is image processing equipment for converting a low resolution image into a high resolution image enabling to reproduce a low resolution pixel shape being maintained in a high resolution image. There are provided a storage (31) for storing a low resolution image and a resolution converter (32) for converting a low resolution target pixel into a plurality of high resolution pixels. A conversion process is carried out as follows: First, a target pixel stored in the storage (31) and pixels positioned on the upper, lower, right and left respectively adjacent to the target pixel are referred to. Then, according to the above-mentioned reference result, the converter converts each low resolution pixel into a plurality of high resolution pixels so that the low resolution pixel shape is reproduced in a high resolution image to maintain compatibility in the print results.

### FIELD OF THE INVENTION

The present invention relates to an image processing method, image processing equipment and image forming equipment using same, for creating a high resolution image from a low resolution image data sent from a host computer. More particularly, the present invention relates to an image processing method, image processing equipment and image forming equipment for converting the low resolution image provided in a bitmap memory into the high resolution image.

### BACKGROUND OF THE INVENTION

In the field of high-speed printers, a page printer based on a dry electrophotographic system is widely used. The following systems are currently in use for exposing an image onto a photosensitive drum: One is a laser exposure system and the other is a system using a light emitting element array such as LED. In the laser exposure system, because the exposure is carried out using an optical mechanism such as a polygon mirror, an optical mechanical control is necessary as well as adjustment of such optical mechanism. On the other hand, in case of the system using light emitting element array, such mechanical control for polygon mirror is not required. Because a simple control is sufficiently required for this system, a printer using a light emitting element array in exposure means, especially using an LED is now increasing.

In a printer, it is required to receive image data having various grades of resolution to form an image. However, an LED array head has a fixed numbers of light emitting elements with a constant interval. Therefore a plurality of LED heads are to be required in a printer in order to support different grades of resolution by a single printer. For example, in case the resolutions of 240 dpi (dots per inch) and 400 dpi are to be supported, two LED heads having 240 dpi and 400 dpi must be mounted in a printer.

Meanwhile, recent progress in micro-machining technology for electronic elements has brought about a high resolution LED head. Instead of preparing a plurality of LED heads having different resolutions, it becomes possible to provide a single LED head having high resolution to support low resolution images, for example, to provide an LED head of 1200 dpi to support the resolution of both 240 dpi and 400 dpi.

The number of light emitting diodes in an LED head depends on a print width and the resolution. For example, in case of 240 dpi, 240 light emitting diodes are aligned per inch, else in case of 1200 dpi, 1,200 light emitting diodes are aligned per inch. Accordingly, in case of supporting both 240 dpi and 400 dpi by an LED having 1200 dpi, it is necessary to convert the data to be sent to the LED head having 1200 dpi into a data having a resolution of 1200 dpi. That is, a conversion of an image data having 240 dpi into an image data having 1200 dpi is required.

In FIGS. 17 and 18, printing flows used in a conventional printer are shown. As shown in FIG. 17, a host computer 100 issues a print command to a printer 200. The print command indicates information such as a font type and a layout for printing and an overlay form for use, transmission of image data and vectors (for rendering a line, circle, etc.)

Printer 200 analyzes the print command received from host computer 100 (command analysis 210), and renders the indicated font and overlay form 230, the received image and vectors into a bitmap memory 240 (rendering process 220).

Generally, there are two methods for printing a low resolution print resource 110 from host computer 100 using a high resolution printer.

As shown in FIG. 17, the first method is that a driver/writer 120 or the like in host computer 100 processes data corresponding to a high resolution. In this case, the host computer 100 identifies the resolution of the printer 200 (i.e. 1200 dpi) to convert the resolution of the image data (for example, from 240 dpi to 1200 dpi) to send, to download a font or overlay for 1200 dpi to printer 200 to designate, and so on.

When the print command from host 100 is standardized so that the command does not depend so much on the printer resolution, a process for corresponding to high resolution is carried out in a rendering processor 220 provided on the printer side, to render finally with the resolution identical to that of LED head 250 (i.e. 1200 dpi) into the bitmap memory 240. In this case, the rendering processor 220 in the printer 200 performs such functions as developing a font (outline font, to 1200 dpi) to paste, converting the resolution of image data received from the host 100 (to 1200 dpi), etc.

There may be a problem, however, when a conventional printer having two LED heads of 240/400 dpi for printing with respective resolutions is to be modified to a new method having a single LED head of 1200 dpi to print 240/400 dpi, a great deal of design modification is required. For example, when there is required a design modification of rendering processor 220 formerly processing 240 dpi newly to process 1200 dpi, twenty-five times (=5×5) of processing capability is required. Also, a bit map memory having twenty-five times capacity becomes necessary.

To avoid such great deal of modification, there has been considered another method. In this method, a resolution conversion mechanism 260 is provided between bitmap memory (for 240 dpi) 240 and LED head 250, as shown in FIG. 18. Here, a bitmap data of 240 dpi is converted into a bitmap data of 1200 dpi.

For this resolution conversion method, there is a known conventional art in which simply a plurality of high resolution dots are allotted to a single low resolution dot. For example, as shown in FIG. 19, 5×5 dots of 1200 dpi are allotted for a single dot of 240 dpi. Similarly, 3×3 dots are allotted for a 400 dpi dot.

A single dot is represented by around pixel in printing. According to the above-mentioned method, therefore, a pixel rendered with a circle in 240 dpi printing is represented in a square shape in case of 1200 dpi, since one dot in 240 dpi corresponds to a plurality of small dots in 1200 dpi. Accordingly, in 1200 dpi, an oblique dither offends the eye, affording a different impression from the original print result in 240 dpi.

In order to improve the oblique dither, a smoothing technique has been proposed, as shown in FIG. 20. This smoothing is a technique to scrape away edges or to fill up gaps, etc. referring to the status of surrounding pixels. This produces no problem as far as smoothing for characters or line drawings are concerned. However, it may cause a problem when the smoothing processing is performed on a two-dimensional bar code or an image photo, possibly resulting in error recognition of a matrix pattern of the two-dimensional bar code or producing tones different from the original photo. For example, as shown in FIG. 21, undesired effects such as unclear boundary in the two-dimensional bar code or a deformed image are produced.

In order to avoid such inconveniences, various methods have been proposed. Such methods include; an advanced smoothing algorithm using pattern recognition of a wide range of surrounding pixels to select the most appropriate smoothing means; or a smoothing control means of selecting whether or not the smoothing is to be performed using flags on an area by area basis. However, these smoothing techniques bring about a complicated sequence causing an increased circuit. This produces reduction in image processing capability as well as a problem of cost increase.

### SUMMARY OF THE INVENTION

Accordingly, it is an object of the present invention to provide an image processing method, image processing equipment and image forming equipment using the method for reproducing a low resolution pixel shape with a simplified sequence in high resolution printing.

It is another object of the present invention to provide an image processing method, image processing equipment and image forming equipment using the method for reproducing a low resolution pixel shape by allocating high resolution pixels to maintain compatibility in the printed images.

It is still another object of the present invention to provide an image processing method, image processing equipment and image forming equipment using the method to maintain compatibility in high resolution print results so that reproduction at a different resolution can be performed using a single head.

In order to attain the aforementioned objects, an image processing method according to the present invention includes: a reference step for referring a target pixel and upper, lower, right and left pixels adjacent to the target pixel in a low resolution image; and a conversion step for converting the low resolution target pixel into a plurality of high resolution pixels according to the result of the reference step, so as to reproduce the low resolution pixel shape by the converted high resolution pixels.

According to the present invention, as the conversion is performed so as to reproduce a low resolution pixel shape at a high resolution, it is possible to maintain compatibility in the print results. Furthermore, because the conversion method refers to only pixels adjacent to the target pixel, in addition to the target pixel, advantages of reproducing at a high resolution can be realized using more simplified circuit configuration than the circuit required for achieving a complicated smoothing method.

According to the present invention, the conversion step preferably comprises the step of selecting a dot pattern from a pattern generator having a plurality of post-conversion dot patterns so as to reproduce the low resolution pixel shape using the plurality of high resolution pixels. Accordingly, the plurality of high resolution pixels are easily generated to reproduce the low resolution pixel shape using the selected dot pattern.

According to the present invention, preferably the conversion step comprises the step of converting the target pixel to the plurality of high resolution pixels so as to reproduce each adjacent pixel shape when the adjacent pixel is a ‘black’ dot. This enables easy conversion to the plurality of high resolution pixels for reproducing the low resolution pixel shape.

Further scopes and features of the present invention will become more apparent by the following description of the embodiments with the accompanied drawings.

### BRIEF DESCRIPTION OF THE DRAWINGS

FIG. 1 shows a configuration diagram of an embodiment of image forming equipment according to the present invention.

FIG. 2 shows a block diagram of a major portion of an LED head shown in FIG. 1.

FIG. 3 shows an illustration of the LED head operation shown in FIG. 2.

FIG. 4 shows an operation illustration of the resolution conversion mechanism shown in FIG. 1.

FIG. 5 shows a block diagram of a resolution conversion mechanism shown in FIG. 1.

FIG. 6 shows an illustration of pattern generators shown in FIG. 5.

FIG. 7 shows a block diagram of a major portion of a resolution converter shown in FIG. 5.

FIG. 8 shows an illustration of an input line register shown in FIG. 7.

FIG. 9 shows an illustration of a source coordinate counter shown in FIG. 7.

FIG. 10 shows an illustration of a destination Y counter shown in FIG. 7.

FIG. 11 shows a flowchart (part 1) of the conversion processing in the conversion controller shown in FIG. 7.

FIG. 12 shows a flowchart (part 2) of the conversion processing in the conversion controller shown in FIG. 7.

FIG. 13 shows a flowchart (part 3) of the conversion processing in the conversion controller shown in FIG. 7.

FIG. 14 shows a flowchart (part 4) of the conversion processing in the conversion controller shown in FIG. 7.

FIGS. 15(A) and 15(B) show an illustration of conversion operation in the configuration shown in FIG. 7.

FIG. 16 shows an example illustration of the conversion result obtained from the configuration shown in FIG. 7.

FIG. 17 shows a configuration diagram of a conventional printer.

FIG. 18 shows a configuration diagram of another conventional printer.

FIG. 19 shows an illustration of a conventional resolution conversion method.

FIG. 20 shows an illustration of another conventional resolution conversion method.

FIG. 21 shows an illustration of image output example according to the conventional method shown in FIG. 20.

### DETAILED DESCRIPTION OF THE PREFERRED EMBODIMENTS

The preferred embodiments of the present invention are described hereinafter referring to the charts and drawings, wherein like numerals or symbols refer to like parts. Image forming equipment, resolution conversion mechanism, and other embodiments are described in order.

### Image Forming Equipment

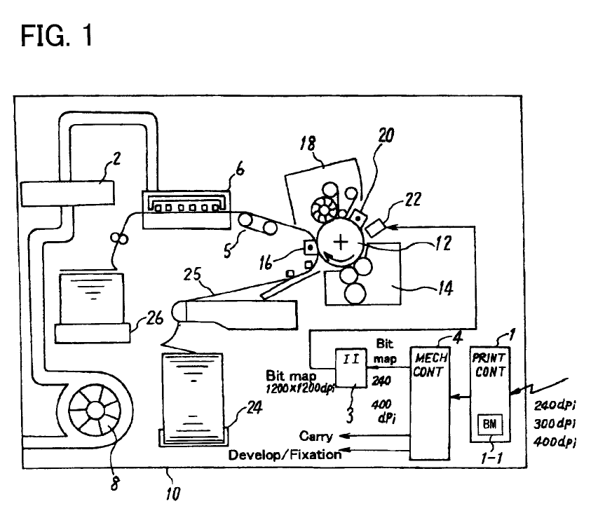

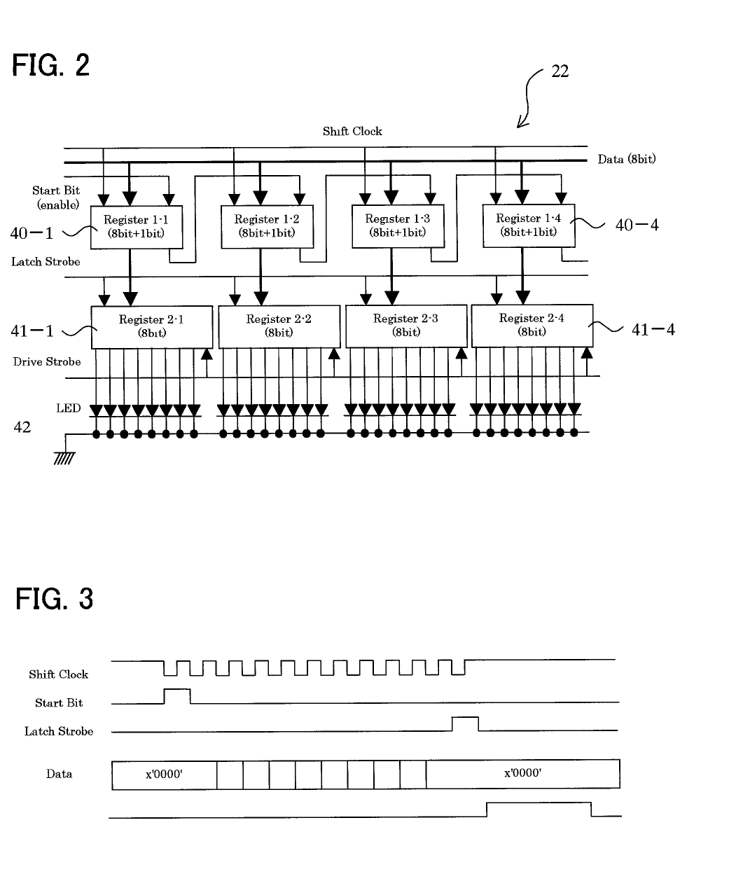

FIG. 1 shows an overall block diagram of an embodiment of the image forming equipment in the present invention. FIG. 2 shows a block diagram of to a major portion of an LED head shown in FIG. 1, and FIG. 3 shows an operation illustration of the LED head shown in FIG. 2.

In FIG. 1, there is illustrated an electrophotographic page printer. As shown in this figure, a main body of a printer 10 is constructed by an electrophotographic mechanism. A photosensitive drum 12 is charged by a charger 20, and then is image-exposed by an LED (light emitting diode) head 22. Thus a latent image is produced on photosensitive drum 12. A developing unit 14 supplies two-component developing agent to the photosensitive drum 12 to develop the latent image to a toner image. A transfer unit 16 transfers the toner image produced on photosensitive drum 12 to a sheet 25. A cleaning mechanism 18 eliminates the charge on photosensitive drum 12 after the image transfer as well as eliminates residual toner.

The sheet 25 is constituted by a continuous form and stacked in a hopper 24. The sheet 25 in the hopper 24 is guided to a transfer position by a feeding mechanism 5, and then is accommodated into a stacker 26 through a flush fixing unit 6. The flush fixing unit 6 fixes the toner image onto the sheet 25 using flush light.

The printer 10 is capable of printing in such a high speed as, for example, more than 100 sheets per minute. This produces a large amount of toner sublimates caused by the flush fixing. To eliminate these sublimates, a filter 2 and an exhaustive fan 8 are provided.

The printer 10 is provided a printer controller 1, a mechanical controller 4, and a resolution conversion mechanism 3. The printer controller 1 analyzes a command sent from a non-illustrated host computer to generate an internal command and a print data (bitmap data). The print data is deployed to a bitmap memory 1-1. The mechanical controller 4 controls the feeding mechanism 5, development and fixing mechanisms 24, 16 and 6 according to the internal command. Further, the mechanical controller 4 outputs the print data to the resolution conversion mechanism 3.

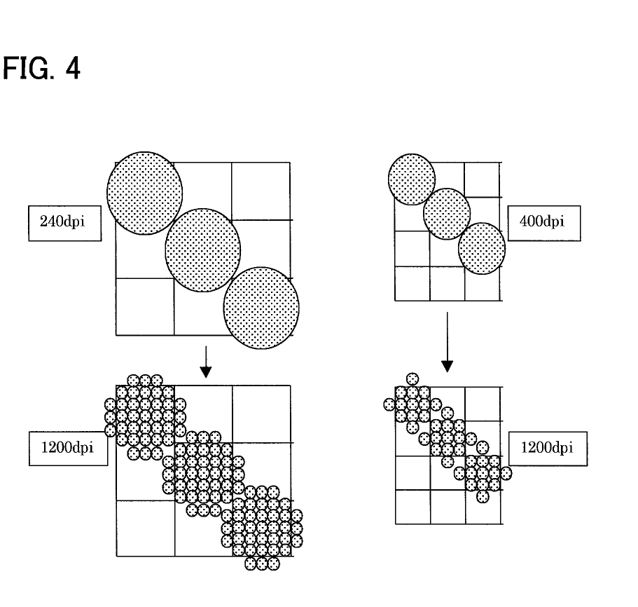

The resolution conversion mechanism 3 processes a bitmap data of low resolution (for example, 240 dpi or 400 dpi) to generate a high resolution bitmap data (for example, 1200 dpi) to drive LED head 22, as will be explained later using FIG. 4, etc. Thus, a high-resolution image that is compensated a low-resolution image data by dot is formed on the sheet 25.

Now, referring to FIGS. 2 and 3, the LED head 22 is explained. As shown in FIG. 3, a ‘start bit’ is added on the top of data to be transmitted to LED group 42. The start bit is firstly latched in a first register 40-1, then is successively shifted to first registers 40-2, 40-3, . . . , in other words among a first register group 40-1 to 40-4, triggered by a shift clock.

This start bit also functions as a ‘write enable’ signal for the first register group 40-1 to 40-4. When the start bit is asserted at the top of the data, the first register 40-1 latches the data and the start bit triggered by the edge of the shift clock. Then, by the succeeding shift clock edge, the first register 40-2 latches the data and the start bit. In such a manner, data is successively accommodated on an 8-bit unit in the first registers 40-1, 40-2, 40-3 and 40-4 triggered by the shift clock edges.

On asserting a latch strobe, data in the first register group 40-1 to 40-4 are latched simultaneously to a second register group 41-1 to 41-4. The data accommodated in the second register group 41-1 to 41-4 are output by a ‘drive strobe’ to emit light by LED 42.

A number of LED (light emitting diodes) 42 is determined depending on a print width and a resolution. For example, in case of 1200 dpi, 1,200 light emitting diodes a realigned per inch. The first registers 40-1 to 40-4 and the second registers 41-1 to 41-4 are allocated having the number determined by the number of light emitting diodes 42. Therefore, it is essential that the data size transmitted to LED head 22 be correspondent to this resolution.

Namely, in case LED head 22 having 1200 dpi is used to support both resolutions 240 dpi and 400 dpi, the resolution of data to be transmitted finally to LED head 22 having 1200 dpi must be 1200 dpi. For this purpose, the resolution conversion mechanism 3 converts a bitmap data having either 240 dpi or 400 dpi to a transmission data having 1200 dpi.

According to the present invention, when converting a low resolution image into a high resolution image, the resolution conversion mechanism 3 allocates high resolution pixels so as to reproduce a pixel shape of the low resolution image, thus maintaining compatibility of a pixel in print results as shown in FIG. 4. As will be explained later, for example, a plurality of 1200 dpi pixels are allocated to reproduce one round pixel having 240 dpi. Similarly, a plurality of 1200 dpi pixels are allocated to reproduce one round pixel having 400 dpi.

In the foregoing example, LED head using LED is taken as an example of the head for exposure. It may also be possible to use other types of heads having other light emitting elements, for example, a liquid crystal shutter. In addition, the image forming equipment may be applied not only the printer but a photocopier, facsimile equipment, etc.

### Resolution Conversion Mechanism

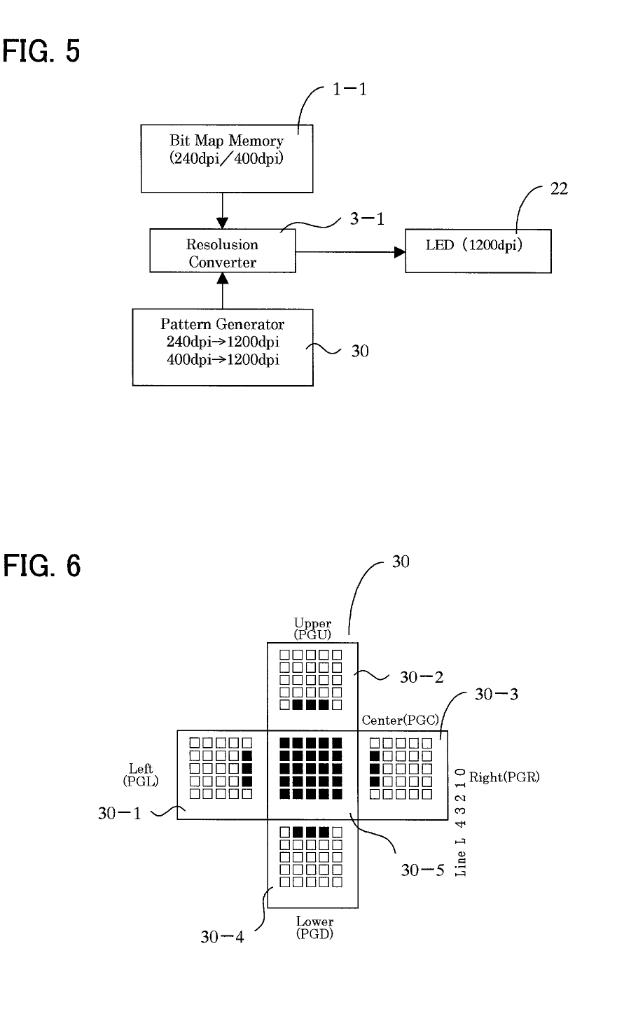

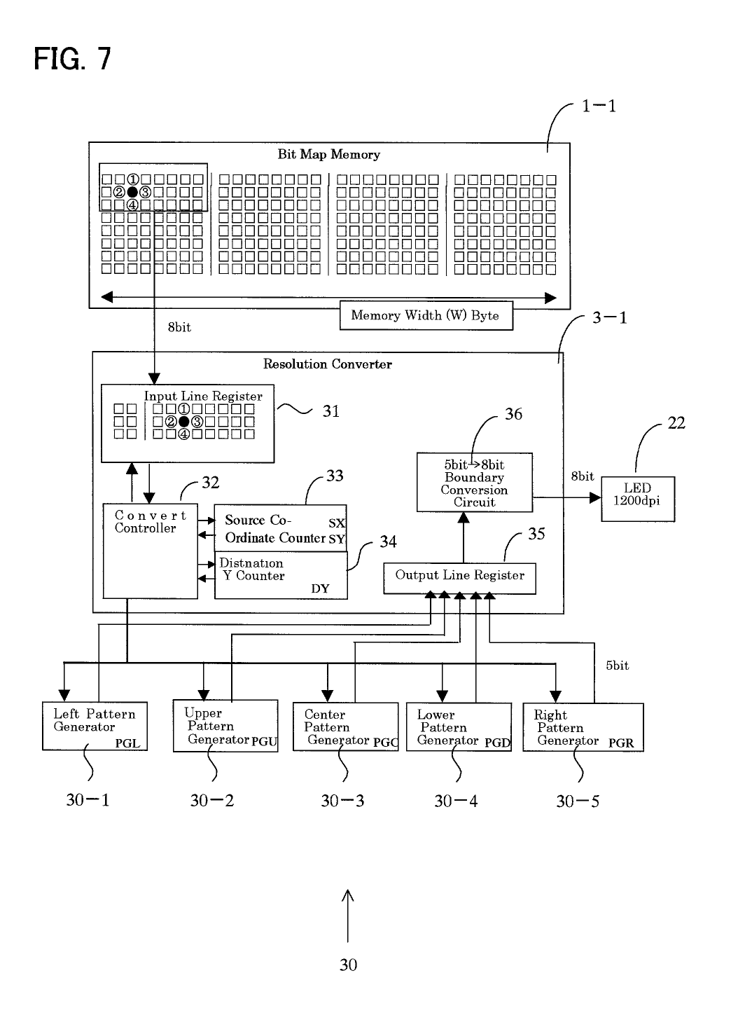

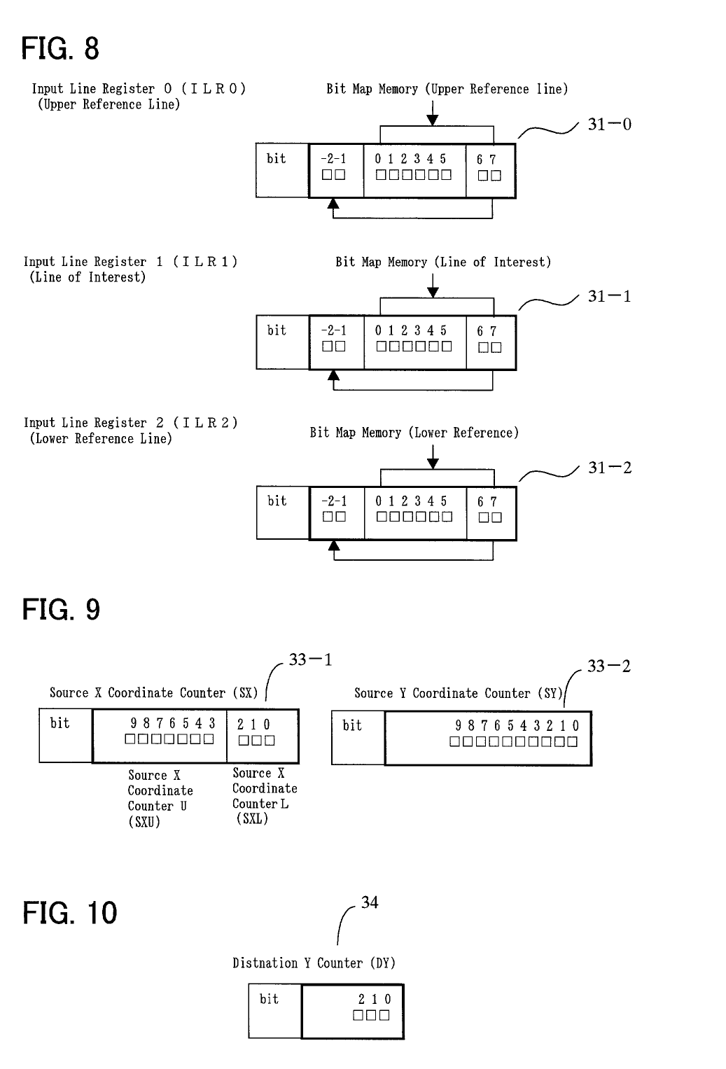

The resolution conversion mechanism is explained hereafter specifically using FIG. 5 to FIG. 10. FIG. 5 shows the resolution conversion mechanism according to an embodiment of the present invention. FIG. 6 shows a configuration diagram of the pattern generators shown in FIG. 5; FIG. 7 shows a block diagram of the resolution converter shown in FIG. 5; FIG. 8 shows an illustration of input line register shown in FIG. 7; FIG. 9 shows a source coordinate counter shown in FIG. 7; FIG. 10 shows an illustration on a destination Y counter shown in FIG. 7.

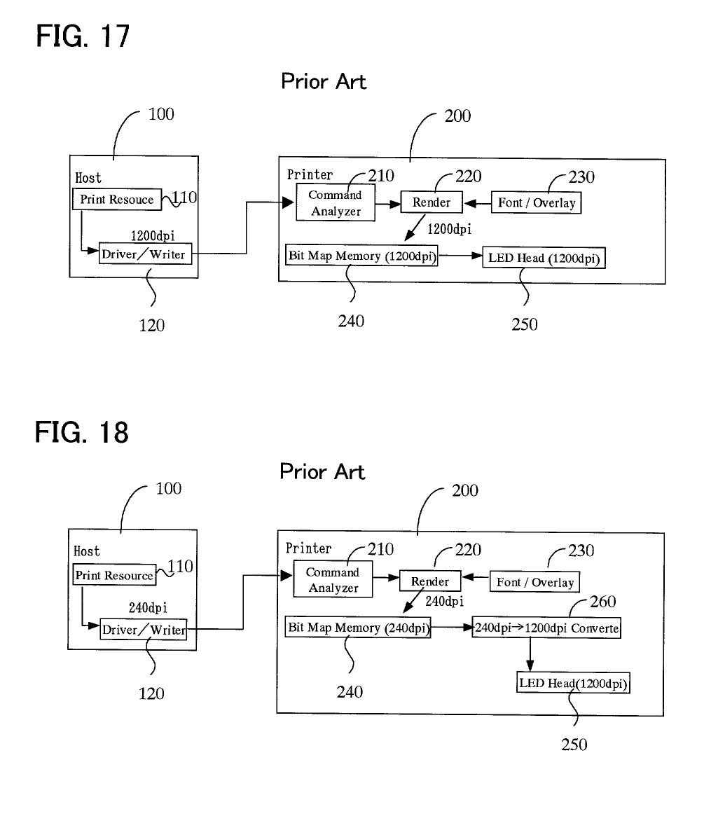

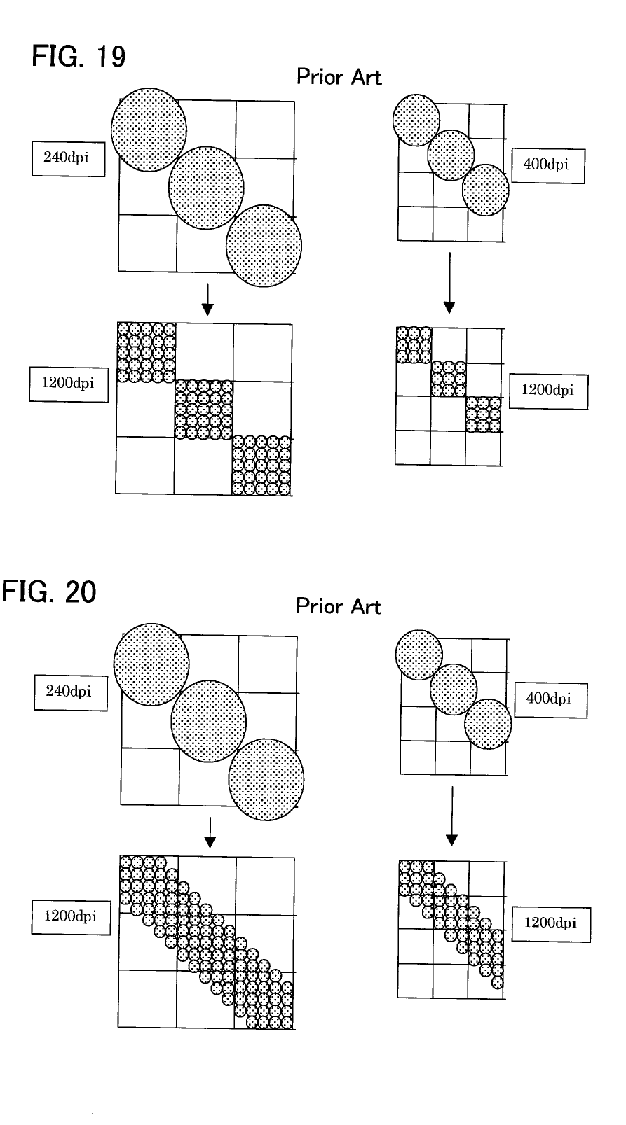

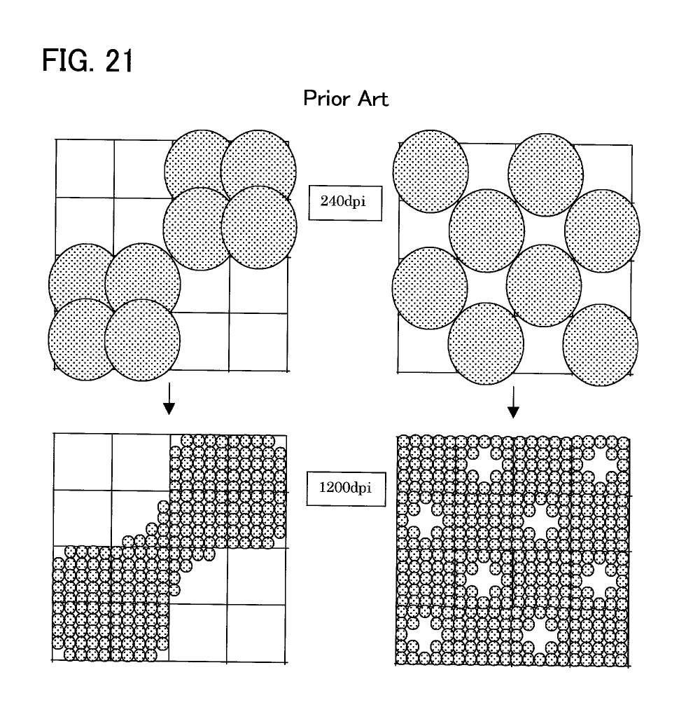

As shown in FIG. 5, the resolution conversion mechanism 3 is constituted by a resolution converter 3-1 and a pattern generator 30. The bitmap memory 1-1 connected to the resolution converter 3-1 stores an image rendered by rendering processor (which corresponds to 220 in FIG. 17) in printer controller 1 according to a print command issued by a host computer. Here, the print command includes; indication on a font type and allocation for print, and an overlay for use; image data transmission; and vectors for rendering lines, circles, etc.

The resolution converter (circuit) 3-1, while reading out an image data from the bitmap memory 1-1, converts the resolution of the data to output to LED head (1200 dpi) 22. The pattern generator 30 stores patterns to be used when the resolution converter 3-1 refers to a dot conversion format during performing resolution conversion.

The pattern generator 30 has pixel conversion patterns for use in resolution conversion provided for respective resolutions (240 dpi to 1200 dpi, and 400 dpi to 1200 dpi). The resolution conversion circuit 3-1 performs to convert the resolutions of 240 dpi to 1200 dpi, or 400 dpi to 1200 dpi while referring to the conversion patterns provided in the pattern generator 30, and outputs data to the LED head (1200 dpi) 22.

The pattern generator 30 functions to generate pixel patterns for use in the resolution conversion. In FIG. 6, there is shown an example of a pixel pattern for use in the conversion from 240 dpi to 1200 dpi. The pattern generator 30 is constituted by five (5) pattern generator (cells) 30-1 to 30-5 each having 5×5 bits. Five-bit pattern is read out to each cell by designating the number 0 to 4 of a line number L. The pattern generator 30 outputs fivebits ‘00000’ when no readout designation is specified.

In the case of resolution conversion from 240 dpi to 1200 dpi, it is necessary to represent a pixel group in 1200 dpi for producing an identical shape to a round pixel of one dot in 240 dpi. For this purpose, one dot in 240 dpi is converted to a center pattern 30-5 consisting of 5×5 dots, as shown in FIG. 6, added by right, left, upper and lower patterns 30-1 to 30-4. Therefore, in addition to center pattern 30-5 consisting of 5×5 black dots, other four sets of 5×5 dot patterns are stored to reproduce above-mentioned one round pixel having 240 dpi; namely right, left, upper and lower patterns 30-1 to 30-4 surrounding center pattern 30-5.

Next, the resolution converter 3-1 is explained using FIG. 7. In FIG. 7, there is shown an example of the resolution converter, in which a 240 dpi image is read out from the bitmap memory 1-1 to perform the pixel conversion into 1200 dpi to output to the LED 22.

The resolution converter 3-1 reads out a 240 dpi image to store into input line register 31. At this time, totally three (3) lines, namely the line of interest (the line having a ‘black’ dot ●), the upper line and the lower line, are stored into the input line register 31. Here, in this input line register 31, two (2) bits on the left end of the line which has been processed previously are also stored. These bits are preserved for use in the pixel conversion of the left end and the right end of the line of interest.

The conversion controller 32 processes the image data of the line stored in the input line register 31 on a bit by bit basis. The conversion controller 32 determines whether each of the five pixels, i.e. the pixel of interest (●), the upper pixel \mathring{1}, the left pixel \mathring{2}, the right pixel \mathring{3}, and the lower pixel \mathring{4}, is ‘black’ or ‘white’, to process a target pixel. When determining that the pixel is ‘black’, a pattern corresponding to the determined pixel location is read out from the pattern generators 30-1 to 30-5.

More specifically, when the upper pixel \mathring{1} is ‘black’, then the upper pattern is read out from the upper pattern generator 30-2. When the left pixel \mathring{2} is ‘black’, the left pattern is read out from the left pattern generator 30-1. Similarly, when the right pixel \mathring{3} is ‘black’, the right pattern is read out from the right pattern generator 30-5, and when the lower pixel \mathring{4} is ‘black’, the lower pattern is read out from the lower pattern generator 30-4. Further, when the target pixel is ‘black’, then the center pattern is read out from the center pattern generator 30-3.

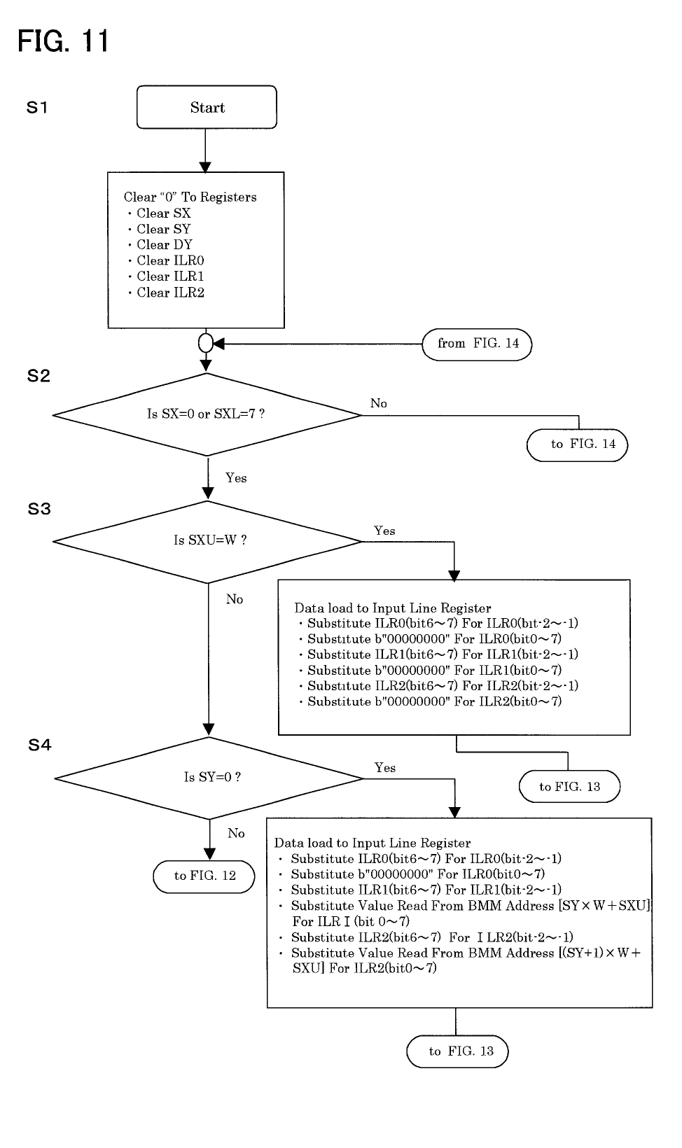

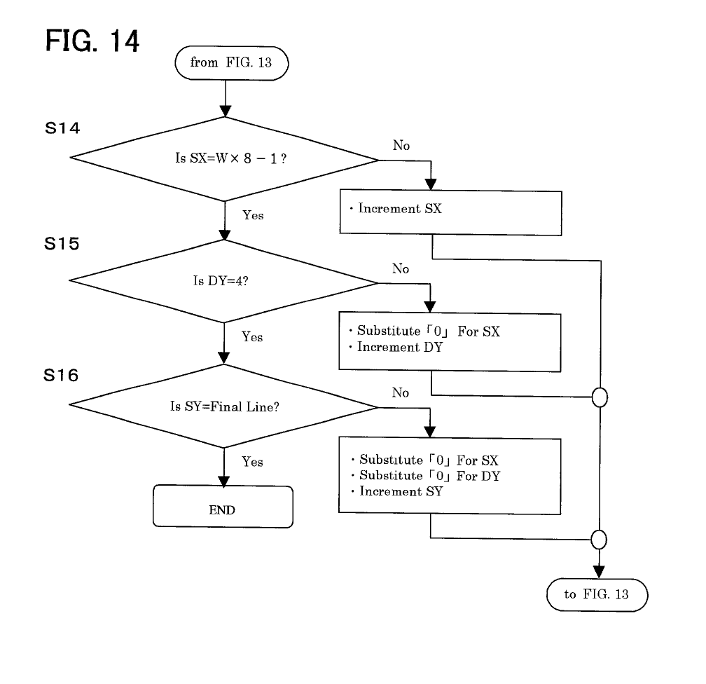

The above operation takes place concurrently. Five-bit patterns respectively read out from the pattern generators 30-1 to 30-5 are performed OR operation in an output line register (OLR) 35, to input to a boundary conversion circuit 36. The boundary conversion circuit 36 performs a boundary conversion from five (5) bits to eight (8) bits, to transfer 1200 dpi/8 bit data to LED head 22. The locations of pixels processed by this conversion controller 32 are calculated by source coordinate counter 33 and destination Y counter 34 for use in the conversion processing which is explained later using FIGS. 11 to 14.

As shown in FIG. 8, the input line register 31 are constituted by three (3) input line registers (ILR0 to ILR2) 31-0 to 31-2 respectively consisting of registers having ten (10) bits. In the input line register 31-1, a ten-bit image data of the line of interest is loaded for performing resolution conversion. In the input line register 31-0, a ten-bit image data of the upper reference line of interest is loaded, and also in the input line register 31-2, a ten-bit image data of the lower reference line of interest is loaded, respectively from the bitmap memory 1-1.

An eight-bit data (one byte) stored in the bitmap memory 1-1 is loaded into the bits #0 to #7 of each input line register 31-0 to 31-2. At this time, two (2) bits #6 and #7 are saved to the bits #-2 and #-1 of each input line register 31-0 to 31-2.

The source coordinate counter 33 is a counter for indicating the locations of pixels of the bitmap 1-1 being currently processed using X and Y coordinates. The source coordinate counter 33 are constituted by a source X-coordinate counter (SX) 33-1 and a source Y-coordinate counter (SY) 33-2. The source X-coordinate counter 33-1 is further constituted by a source X-coordinate counter U (SXU) for indicating the location on a byte-by-byte basis and a source X-coordinate counter L (SXL) for indicating the location on a bit-by-bit basis.

The destination Y counter (DY) 34 indicates an address of five (5) vertical bits of each pattern generator 30-1 to 30-5.

Now, referring to FIGS. 11 to 14, the conversion processing in the conversion controller 32 shown in FIG. 7 is explained below. Here, in FIGS. 11 to 14, symbols for registers, signals and constants denote as follows:

SY: the source Y-coordinate counter

SX: the source X-coordinate counter

SXU: the source X-coordinate counter U

SXL: the source X-coordinate counter L

DY: the destination Y counter

ILR0: the input line register 0 (for the upper reference line)

ILR1: the input line register 1 (for the line of interest)

ILR2: the input line register 2 (for the lower reference line)

OLR: the output line register

BMM: the bitmap memory

PGC: the center pattern generator

PGU: the upper pattern generator

PGD: the lower pattern generator

PGR: the right pattern generator

PGL: the left pattern generator

W: memory width value of the bitmap memory

(S1) When the conversion shown in FIG. 11 is initiated, all registers are cleared to zeroes. Namely, SX, SY, DY, ILR0 to ILR2 are all cleared.

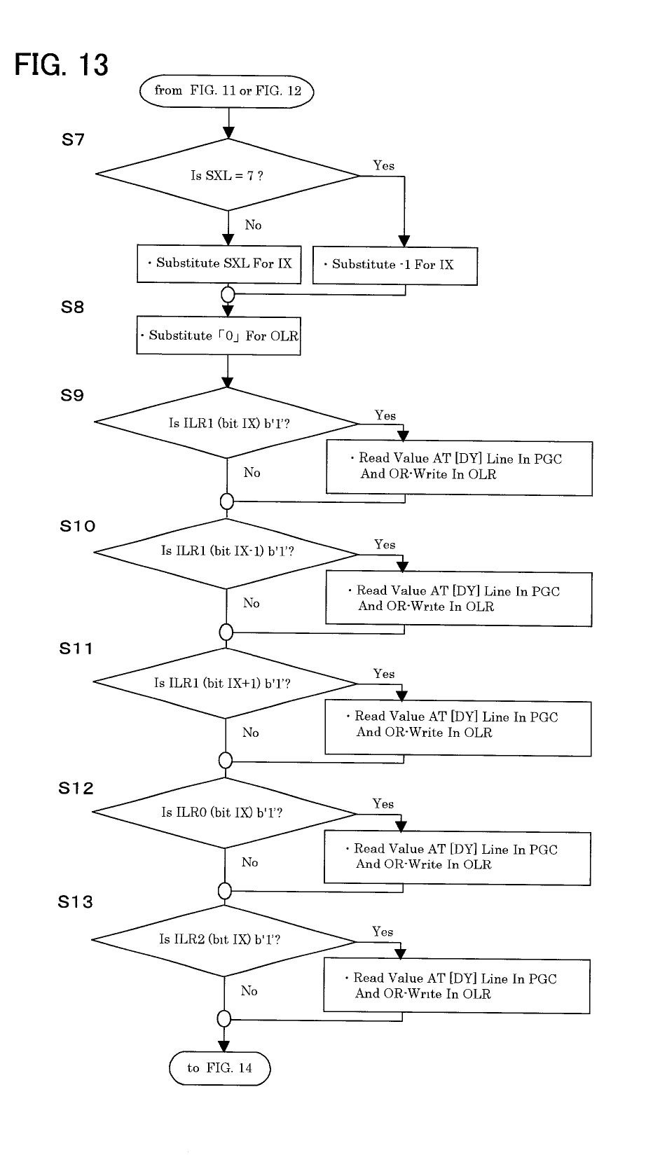

(S2) A decision is made whether SX=‘0’ or SXL=‘7’. Here, SX=‘0’ means the value of SX is an initial value, while SXL=‘7’ means a bit counter has counted one byte. When SX is not the initial value ‘0’ and SXL has not counted one byte, then the process proceeds to a pattern reference processing shown as step S7 in FIG. 13.

(S3) On the other hand, when either SX is the initial value ‘0’ or SXL has counted one byte, data loading to the input line register 31 is carried out. This loaded data differs depending on X-coordinate and Y-coordinate of the bitmap 1-1. First, SXU is checked whether or not the value thereof is W (horizontal bitmap width). When SXU=W, then data are loaded into the input line registers as shown below, then the process proceeds to the pattern reference processing of step S7 shown in FIG. 13.

In ILR0 (bits #-2 to #-1), ILR0 (bits #6 to #7) is substituted.

In ILR0 (bits #0 to #7), b ‘00000000’ is substituted.

In ILR1 (bits #-2 to #-1), ILR1 (bits #6 to #7) is substituted.

In ILR1 (bits#0 to#7), b ‘00000000’ is substituted.

In ILR2 (bits #-2 to #-1), ILR2 (bits #6 to #7) is substituted.

In ILR2 (bits #0 to #7), b ‘00000000’ is substituted.

(S4) When SXU is not W (horizontal bitmap width) then a decision is made whether SY (Y-coordinate)=‘0’. When SY=‘0’, data are loaded into the input line registers as shown below, then the process proceeds to the pattern reference processing of step S7 shown in FIG. 13.

In ILR0 (bits #-2 to #-1), ILR0 (bits #6 to #7) is substituted.

In ILR0 (bits #0 to #7), b ‘00000000’ is substituted.

In ILR1 (bits #-2 to #-1), ILR1 (bits #6 to #7) is substituted.

In ILR1 (bits #0 to #7), the value being read out from BMM address [SY×W+SXU] is substituted.

In ILR2 (bits #-2 to #-1), ILR2 (bits #6 to #7) is substituted.

In ILR2 (bits #0 to #7), the value being read out from BMM address [(SY+1)×W+SXU] is substituted.

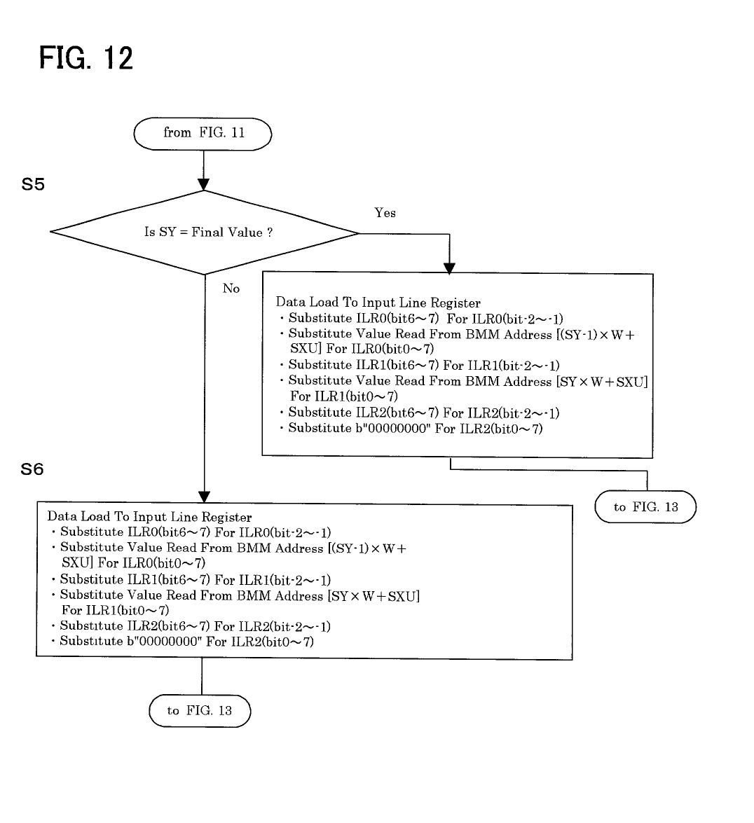

(S5) When SY (Y-coordinate) is not equal to ‘0’, the process proceeds to FIG. 12, to decide whether SY is the final value (that is, the completion position of the process in Y-coordinate). When SY is the final value, data are loaded into the input line registers as shown below, then the process proceeds to the pattern reference processing of step S7 shown in FIG. 13.

In ILR0 (bits #-2 to #-1), ILR0 (bits #6 to #7) is substituted.

In ILR0 (bits #0 to #7), the value being read out from BMM address [(SY−1)×W+SXU] is substituted.

In ILR1 (bits #-2 to #-1), ILR1 (bits #6 to #7) is substituted.

In ILR1 (bits #0 to #7), the value being read out from BMM address [SY×W+SXU] is substituted.

In ILR2 (bits #-2 to #-1), ILR2 (bits #6 to #7) is substituted.

In ILR2 (bits #O to#7), b ‘00000000’ is substituted.

(S6) When SY (Y-coordinate) is not the final value, data are loaded into the input line registers as shown below, then the process proceeds to the pattern reference processing of step S7 shown in FIG. 13.

In ILR0 (bits #-2 to #-1), ILR0 (bits #6 to #7) is substituted.

In ILR0 (bits #0 to #7), the value being read out from BMM address [(SY−1)×W+SXU] is substituted.

In ILR1 (bits #-2 to #-1), ILR1 (bits #6 to #7) is substituted.

In ILR1 (bits #0 to #7), the value being read out from BMM address [SY×W+SXU] is substituted.

In ILR2 (bits #-2 to #-1), ILR2 (bits #6 to #7) is substituted.

In ILR2 (bits #0 to #7), b ‘00000000’ is substituted.

(S7) Next, a decision is made whether bit count SXL=‘7’. When SXL=‘7’, this means a reach to boundary and therefore the top position ‘−1’ is set to line register reference address IX. Otherwise if SXL is not equal to ‘7’, the value SXL is substituted in reference address IX.

(S8) Next, ‘0’ is substituted in output line register OLR.

(S9) Whether a bit IX in line register ILR1 is b (=bit) ‘1’ is checked. When the bit IX in line register ILR1, namely the target bit, is ‘1’, the value (consisting of five bits) of line #[DY] in the center pattern generator PGD is read out and performed OR operation with the output line register OLR to store thereto.

(S10) Whether a bit IX-1 in line register ILR1 is b (=bit) ‘1’ is checked. When the bit IX-1 in the line register ILR1, namely the left bit of the target bit, is ‘1’, the value (consisting of five bits) of line #[DY] in the right pattern generator PGR is read out and performed OR operation with the output line register OLR to store thereto.

(S11) Whether a bit IX+1 in line register ILR1 is b ‘1’ is checked. When the bit IX+1 in line register ILR1, namely the right bit of the target bit, is ‘1’, the value (consisting of five bits) of line #[DY] in the left pattern generator PGL is read out and performed OR operation with the output line register OLR to store thereto.

(S12) Whether a bit IX in line register ILR0 is b ‘1’is checked. When the bit IX in line register ILR0, namely the upper bit of the target bit, is ‘1’, the value (consisting of five bits) of line #[DY] in the lower pattern generator PGD is read out and performed OR operation with the output line register OLR to store thereto.

(S13) Whether a bit IX in line register ILR2 is b ‘1’ is checked. When the bit IX in line register ILR2, namely the lower bit of the target bit, is ‘1’, the value (consisting of five bits) of line #[DY] in upper pattern generator PGD is read out and performed OR operation with the output line register OLR to store thereto.

(S14) A decision is made whether source X-coordinate counter SX reaches the horizontal bitmap width ‘W×8−1’. When SX is not equal to ‘W×8−1’, SX is incremented by ‘1’ and the process returns back to step S2 shown in FIG. 11.

(S15) Otherwise if SX is equal to ‘W×8−1’, it is checked whether destination Y counter DY is ‘4’. When DY is not equal to ‘4’, then ‘0’ is substituted into SX, and DY is incremented by ‘1’. Then the process returns back to step S2 shown in FIG. 11.

(S16) When the destination Y counter DY is equal to ‘4’, it is checked whether the source Y-coordinate counter SY is the final line. When SY is not the final line, then ‘0’ is substituted into both SX and DY, and SY is incremented by ‘1’ then the process returns to step S2 shown in FIG. 11. On the other hand, when SY is the final line, this denotes that the overall bitmap conversion processing is completed. Thus the process is terminated.

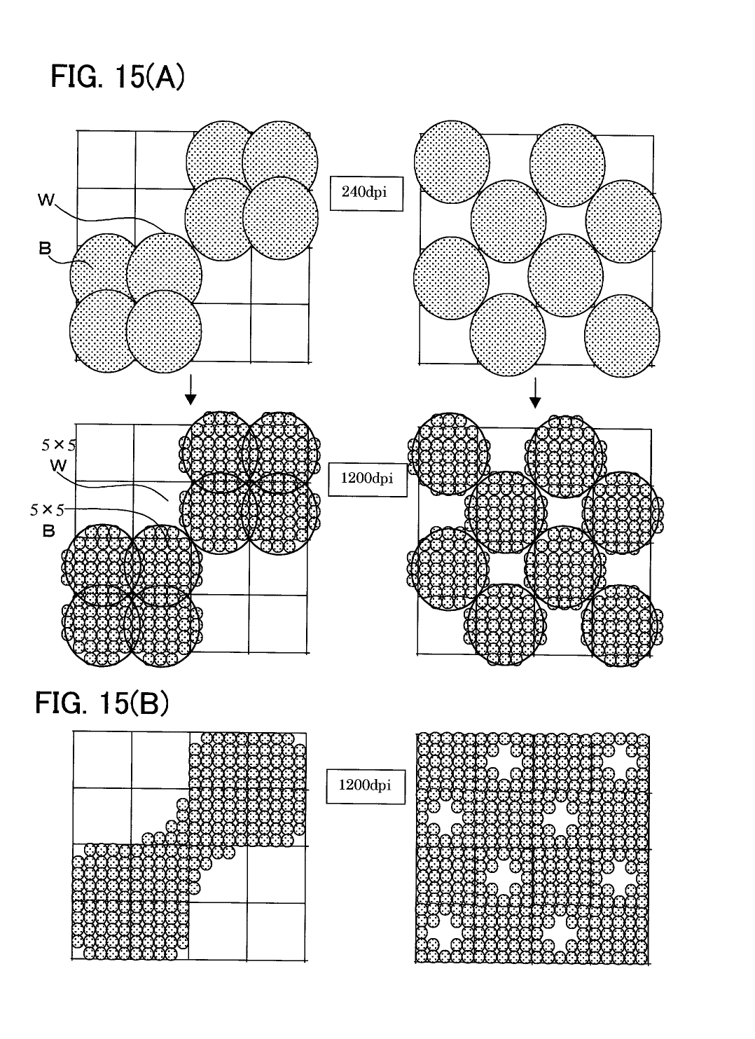

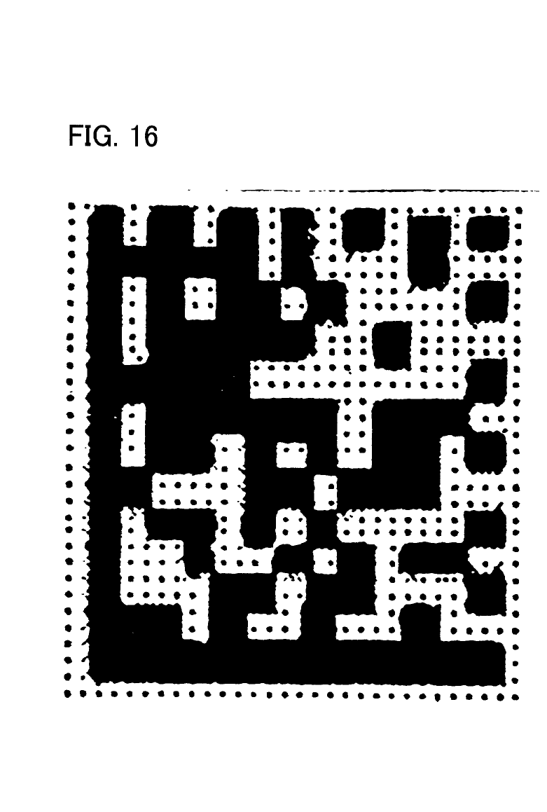

In FIGS. 15(A), 15(B) and 16, there are shown illustrations of resolution conversion processing result according to the present invention. FIG. 15(A) shows a print result of a converted image from 240 dpi to 1200 dpi according to the present invention. FIG. 15(B) shows a print result of the image converted from 240 dpi to 1200 dpi using a conventional smoothing method. On the left side of the figure, an example image of a two-dimensional bar code is shown, while an example of a photographic image is shown on the right. In FIG. 16, there is shown a print result of the two-dimensional bar code shown in FIG. 15.

Comparing the result produced by the method according to the present invention with the result by the conventional method, a single ‘black’ dot B having 240 dpi is converted to 5×5 black dots having 1200 dpi equally in the two methods. However, a single ‘white’ dot W is differently converted into 1200 dpi. That is, according to the method of the present invention, in case a black dot neighbors the white dot of the target dot in either upper, lower, right or left positions in 240 dpi, each dot neighboring the black dot are substituted by a black dot in 1200 dpi, so that the black dot of interest is represented as a round figure. To the contrary, according to the conventional smoothing method, when continuous black dots are obliquely aligned in 240 dpi, a portion of white dots are substituted by black dots so that the neighboring white dots looks like continuous black dots.

As having been explained above, the conversion method according to the present invention enables to reproduce a pixel shape of 240 dpi image at a high resolution maintaining compatibility in the printed results. Because the conversion method of the present invention refers to only the neighboring pixels as well as the target pixel, advantages of reproducing at a high resolution can be realized using simpler circuit configuration than a circuit for a complicated smoothing method.

### Other Embodiments

In the above embodiment, the description is based on the example of converting a 240 dpi image to a 1200 dpi image. As shown in FIG. 4, it is quite similar in case of conversion from a 400 dpi image to a 1200 dpi image. Also, the method of the present invention is applicable to a conversion from a different degree of low resolution to high resolution.

Similarly, the image forming equipment is described taking a printer as an example. However it may also be possible to apply other image forming equipment such as a photocopier, facsimile equipment, etc. Moreover, although the resolution converter is implemented by a processor with a program, it is also possible to construct with hardware only. Further, it may also be possible to construct a resolution converter using a program installed in a processor of printer controller 1.

The conversion method according to the present invention enables to reproduce a low resolution pixel shape at a high resolution while maintaining compatibility in the printed results. Because the conversion method refers to only pixels adjacent to the target pixel, in addition to the target pixel, advantages of reproducing at a high resolution can be realized using more simplified circuit configuration than the circuit required for achieving a complicated smoothing method.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. An image processing method for converting a low resolution image into a high resolution image comprising the steps of:
referring to a target pixel and the upper, lower, right and left pixels adjacent to said target pixel in said low resolution image;
converting said target pixel into a plurality of high resolution pixels according to the result of said reference step, so as to reproduce a pixel shape in said low resolution image by the plurality of high resolution pixels.

2. The image processing method according to claim 1 wherein said converting step comprises a step of:
selecting a dot pattern from a pattern generator having a plurality of dot patterns to be used as converted pixels so as to reproduce said low resolution pixel shape using said plurality of high resolution pixels.

3. The image processing method according to claim 1 wherein said converting step comprises the step of:
converting said target pixel into said plurality of high resolution pixels so as to reproduce said each adjacent pixel shape when said adjacent pixel is a ‘black’ dot.

4. The image processing method according to claim 1 wherein said referring step comprises the steps of:
inputting an image having a plurality of lines to a line register from a bitmap memory which stores said low resolution image; and
referring to said target pixel and said upper, lower, right and left pixels adjacent to said target pixel being input to said line register.

5. The image processing method according to claim 2 wherein said converting step further comprises the step of:
outputting a conversion result obtained through a logical OR operation on said each dot pattern being selected according to the reference result of said each pixel.

6. An image processing equipment for converting a low resolution image into a high resolution image comprising:
storing means for storing said low resolution image; and
resolution conversion means for converting a low resolution target pixel into a plurality of high resolution pixels according to said reference result of referring to said target pixel and the upper, lower, right and left pixels adjacent to said target pixel being stored in said storing means, so as to reproduce said low resolution pixel shape using said plurality of high resolution pixels.

7. The image processing equipment according to claim 6, wherein said resolution conversion means comprises:
a dot pattern generator having a plurality of dot patterns to be used as converted pixels; and
a conversion control means for selecting a suitable dot pattern obtained from said pattern generator so as to reproduce said low resolution pixel shape using said plurality of high resolution pixels.

8. The image processing equipment according to claim 6, wherein said resolution conversion means converts said target pixel into said plurality of high resolution pixels so as to reproduce said each adjacent pixel shape when said adjacent pixel is a ‘black’ dot.

9. The image processing equipment according to claim 6, wherein said storing means comprises:
a line register into which an image having a plurality of lines is input from a bitmap memory storing said low resolution image, and
said resolution conversion means refers to said target pixel and said upper, lower, right and left pixels adjacent to said target pixel being input in said line register.

10. The image processing equipment according to claim 7, wherein said resolution conversion means further comprises:
an output register for outputting a conversion result obtained through a logical OR operation on said each dot pattern being selected according to the reference result of said each pixel.

11. An image forming equipment for reproducing at a high resolution an image originally having low resolution comprising:
storing means for storing said low resolution image;
resolution conversion means for converting a low resolution target pixel into a plurality of high resolution pixels according to the reference result to said target pixel and the upper, lower, right and left pixels adjacent to said target pixel being stored in said storing means, so as to reproduce said low resolution pixel shape using said plurality of high resolution pixels; and
image forming means for reproducing said converted high resolution image.

12. The image forming equipment according to claim 11, wherein said resolution conversion means comprises:
a dot pattern generator having a plurality of dot patterns to be used as converted pixels; and
conversion control means for selecting a suitable dot pattern obtained from said pattern generator so as to reproduce said low resolution pixel shape using said plurality of high resolution pixels.

13. The image forming equipment according to claim 11, wherein said resolution conversion means converts said target pixel into said plurality of high resolution pixels so as to reproduce said each adjacent pixel shape when said adjacent pixel is a ‘black’ dot.

14. The image forming equipment according to claim 11, wherein said storing means comprises:
a line register to which an image having a plurality of lines is input from a bitmap memory storing said low resolution image, and
said resolution conversion means refers to said target pixel and said upper, lower, right and left pixels adjacent to said target pixel being input in said line register.

15. The image forming equipment according to claim 12, wherein said resolution conversion means further comprises:
an output register for outputting a conversion result obtained through a logical OR operation on said each dot pattern being selected according to the reference result of said each pixel.
